(19) United States
(12) Patent Application Publication
(10) Pub. No.: US 2010/0146927 A1
(43) Pub. Date: Jun. 17, 2010

(54) HYBRID POWER FOR CRACKING POWER PLANT CO2

(75) Inventors: Wilmot H. McCutchen, Orinda, CA (US); David J. McCutchen, Portland, OR (US)

Correspondence Address: MARGER JOHNSON & MCCOLLOM, P.C., 210 SW MORRISON STREET, SUITE 400, PORTLAND, OR, 97204, US

(73) Assignee: MCCUTCHEN CO., Portland, OR (US)

(21) Appl. No.: 12/637,641

(22) Filed: Dec. 14, 2009

Related U.S. Application Data
(60) Provisional application No. 61/122,279, filed on Dec. 12, 2008.

(51) Int. Cl. F02C 6/00

(52) U.S. Cl. 60/39.12

(57) ABSTRACT

Power from wind, solar, and other intermittent energy sources cracks carbon dioxide, NOx, SOx, and other emissions from fossil fuel power plants, which provide baseload power to the grid. By this hybrid power system, intermittent sources can be integrated in power generation without compromising the reliability of the grid and without long power line connections. Carbon dioxide becomes, in effect, a storage medium for energy produced by intermittent sources. The CO₂ can be pipelined to sites where wind, solar, tidal or and other intermittent energy sources are available, or power lines can be run from such intermittent sources to convenient sites for cracking.

### BACKGROUND OF THE INVENTION

“Sequestration” (pumping enormous volumes of CO₂ underground and hoping it won't leak out) is impractical for overwhelming technical and political reasons. The clear and convincing case against carbon dioxide sequestration, published by the GAO, can be found at http://www.gao.gov/new.items/d081080.pdf. A need exists for an alternative to sequestration, and the present invention addresses that need.

A preferable approach is to crack captured carbon dioxide and thereby render it harmless, or even useful. Useful cracking byproducts may include syngas, solid carbon, and oxygen. In pending U.S. patent application Ser. No. 12/167,771 entitled “Radial Counterflow Shear Electrolysis” by Wilmot H. McCutchen and David J. McCutchen, filed Jul. 3, 2008, US Pat. App. No. 2009/0200176 (published Aug. 13, 2009), we disclosed a device for cracking carbon dioxide as well as other pollutants between axially-fed counter-rotating disk dynamo electrodes. The present invention addresses the problem of how to power such a device. It also addresses the problem of energy storage for intermittent sources such as wind, solar, tidal, and other renewables.

### IGCC Clean Coal Plants

Integrated Gasification Combined Cycle (IGCC) power plants convert a carbonaceous fuel, such as biomass or coal, into syngas, a mixture of carbon monoxide and hydrogen (CO+H₂). The conversion occurs in a gasifier at temperatures over 700° C. Preferably, the gasifier is supplied by oxygen instead of air, for higher energy density (heating value) in the syngas. Obtaining oxygen for oxygen-blown gasifiers requires a cryogenic air separation unit (ASU), which is a large parasitic load on the plant, 380 kW h/ton (1.37 GJ/ton, or 43.84 kJ/mol of O₂).

The output of the gasifier is separated into carbon dioxide (CO₂) and syngas (CO+H₂). Syngas can be processed by the Fischer-Tropsch synthesis into liquid vehicle fuel (synfuel), or may be fuel for direct combustion. A water-gas shift reactor may increase the hydrogen content of the syngas stream and minimize the CO content by the reaction CO+H₂O =>CO₂+H₂. Fuel from the gasifier goes into a combustor, and output of the combustor, mixed with the separated nitrogen from the ASU, expands through the gas turbine, generating electricity, and becomes gas turbine exhaust, which is used to raise steam for a bottoming cycle. Hence the name “combined cycle”: a Brayton cycle (gas turbine) combined with a Rankine cycle (steam turbine).

### Syntrolysis, the Simultaneous Electrolysis of CO₂ and H₂O

Carbon dioxide capture, which is its separation from the gasifier output or from flue gas, is addressed in pending U.S. patent application Ser. No. 11/827,634 entitled “Radial Counterflow Carbon Capture and Flue Gas Scrubbing,” by Wilmot H. McCutchen, filed Jul. 11, 2007, US Pat. App. No. 2009/0013867 (published Jan. 15, 2009). Alternative means for carbon capture include chemical capture by amine sorbents or chilled ammonia, membranes, and cryogenic separation. Whatever the means used for separating the CO₂ into a relatively pure stream for disposal, the problem remains of what to do with it.

The volume of CO₂ emissions from a modest size (250 MW) coal-fired power plant is 1.7 million tons per year, which occupies a space of approximately a cubic kilometer at STP. Cramming worldwide CO₂ emissions from power plants underground is not a feasible alternative because the amount of space required is enormous, transportation to suitable injection sites is prohibitively expensive, and the injected CO₂ might eventually leak out with fatal results.

Instead of sequestration, and instead of a bottoming Rankine cycle (which wastes water), an alternative is to feed the separated CO₂ from the gasifier and the shift reactor, mixed with steam, into an electrolytic cracker to produce syngas and oxygen. Cracking is the dissociation of the CO₂ and H₂O molecules in the process CO₂+H₂O=>CO+H₂+O₂. Simultaneous electrolysis of carbon dioxide and water has been dubbed “syntrolysis” by Stoot, et al. at the Idaho National Laboratory, who have demonstrated a small-scale solid oxide electrolysis cell. Stoots, et al. U.S. Pat. App. No. 2008/0013338 (published Jan. 31, 2008).

The oxygen from cracking CO₂ could be recycled into the gasifier, saving the cost cryogenic separation in the air separation unit (ASU). The ASU accounts for approximately 30% of the operation and maintenance cost of the IGCC plant, and its operation depends on parasitic energy from the plant. For each mole of CO₂ cracked, a mole of O₂ is produced. The air separation unit uses 42.83 kJ/mol O₂ so for a ton (22,727 moles) of CO₂ there are 22,727 moles of O₂ produced, saving 0.97 GJ per metric ton of oxygen. Oxygen recycling for combustion, even in a conventional powdered coal plant, will reduce the volume of smokestack emissions by 75% through eliminating the nitrogen ballast from air combustion which frustrates chemical carbon capture methods. For post-combustion carbon capture, that is a big plus. So the benefit of oxygen recycling will at least partially offset the cost of carbon cracking, even in existing pulverized coal plants.

### Conventional Coal Plants

Although IGCC is being developed, nearly all coal plants are of the type where the coal is burned to produce steam, and the steam pushes a turbine to turn a generator. Conventional coal plants waste a large amount of water, which goes into the atmosphere from cooling towers. Next to agriculture, power plants are the largest drain on increasingly scarce fresh water resources.

In addition to the water waste, post-combustion carbon dioxide capture and disposal remains an unsolved problem. Despite growing alarm over global climate change, and the fact that coal-fired power plants are the main source of CO₂ emissions, policymakers are paralyzed because coal plants are essential for providing the baseload power that keeps the electricity grid reliable and thus powers air conditioning, refrigeration, motors, electric cars, and electric lighting which populations in the 21st century have come to expect.

The generators at coal plants run all the time, because getting them up to speed takes days. A “spinning reserve” is therefore available when supply exceeds demand. At times of low power demand, such as at night, power is very cheap. Various schemes for energy storage, to avoid wasting this excess energy, have been proposed, such as pumping water into elevated reservoirs. The present invention addresses the need to utilize this cheap energy.

### Intermittent Natural Energy Sources:

Wind, solar, and tidal are intermittent natural energy sources, often lumped in with biomass under the vague rubric of “renewables.” In the present invention, the term “renewables” refers to wind, solar, and tidal energy sources. The good thing about wind, solar, and tidal is that they produce no emissions, unlike biomass, coal, and natural gas, which are carbonaceous energy sources used at power plants for producing reliable electricity. Popular enthusiasm about wind, solar, and tidal energy sources as a solution to the Anthropogenic Global Warming (AGW) problem ignores the fact that such energy sources provide power intermittently, therefore they cannot provide baseload power. Baseload power, typically 50% of peak power, is the amount that is always immediately available to the grid. The devices that connect to the grid depend on baseload power.

At night, or on cloudy days, solar power is not available; and when the wind does not blow, such as on hot days, wind power is not available. So intermittent energy, if it cannot be connected to the grid, must go to waste unless it can be stored somehow, and energy storage is an unsolved problem. Batteries do not have enough energy storage capacity for the task, and hydrogen is a vain hope. Hydrogen as a vehicle fuel will not happen for many years, if at all, and stationary fuel cells are not widely deployed. See the excellent discussion of the storage, production, and distribution problems of hydrogen, and of the limitations of fuel cells, in The Hype About Hydrogen, by Joseph Romm (Island Press 2004). Mr. Romm oversaw hydrogen and transportation fuel cell issues at the Department of Energy during the Clinton administration.

Connecting more than 20% intermittent energy sources to the grid impairs reliability, and thereby imperils economic prosperity, so a different use, other than powering the grid, needs to be found for wind, solar, and tidal energy. The present invention addresses that need and provides means for widely deploying wind, solar, and tidal—notwithstanding transmission line and other grid connection problems—to the point that wide deployment may make such intermittent sources suitable for baseload power in replacement of fossil fuels.

### SUMMARY OF THE INVENTION

The carbon dioxide, NOx, and SOx in coal-fired power plant flue gas or in IGCC gasifier output are cracked by an electromechanical apparatus powered by intermittent energy sources, such as wind, solar, and tidal. The oxygen from cracking is recycled into the plant. Solid carbon and sulfur from CO₂ cracking is recovered as a valuable product. Carbon dioxide thus becomes a form of grid energy storage for renewables such as wind and solar. CO₂ is cracked whenever intermittent energy sources are available, and when spinning reserve exceeds demand at the power plant. The counter-rotating flywheel electrodes of the radial counterflow cracker, which become armatures of homopolar generators when an axial magnetic field is present, act also as a form of energy storage. See “Radial Counterflow Shear Electrolysis” by Wilmot H. McCutchen and David J. McCutchen, filed Jul. 3, 2008, US Pat. App. No. 2009/0200176 (published Aug. 13, 2009), incorporated by reference herein.

### BRIEF DESCRIPTION OF THE DRAWINGS

FIG. 1 shows a flow diagram of the hybrid power system of the present invention applied to a gasification power plant.

### DETAILED DESCRIPTION OF THE INVENTION

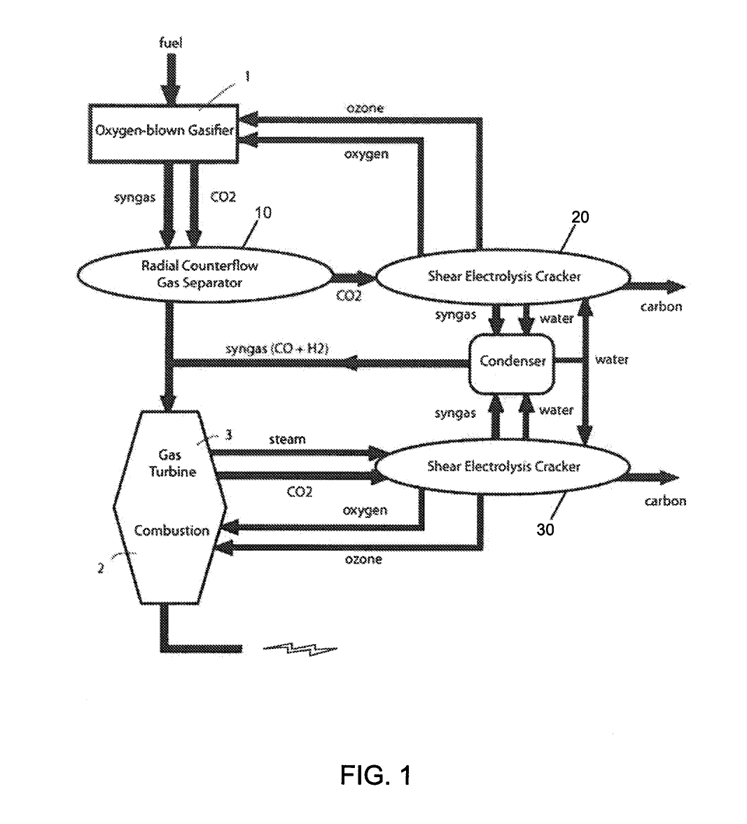

FIG. 1 shows a flow diagram of the hybrid power system of the present invention applied to a gasification power plant. Gasification power plants include those facilities which treat coal, biomass, landfill, or other carbonaceous fuels in a gasifier 1, producing syngas (a mixture of carbon monoxide and hydrogen) which can be processed into liquid fuel by the Fischer-Tropsch synthesis. A fraction of the output of the gasifier 1 is CO₂. A gas separator 10—preferably of the radial counterflow type disclosed in U.S. patent application Ser. No. 11/827,634 entitled “Radial Counterflow Carbon Capture and Flue Gas Scrubbing,” by Wilmot H. McCutchen, filed Jul. 11, 2007, US Pat. App. No. 2009/0013867 (Jan. 15, 2009), incorporated by reference herein—separates CO₂ from the gasifier output. The CO₂ thus captured becomes feed to an electrolytic cracker 20—preferably of the radial counterflow type disclosed in U.S. patent application Ser. No. 12/167,771 entitled “Radial Counterflow Shear Electrolysis” by Wilmot H. McCutchen and David J. McCutchen, filed Jul. 3, 2008, US Pat. App. No. 2009/0200176 (Aug. 13, 2009), incorporated by reference herein—where the captured CO₂ is decomposed.

The dissociation energy (D(O—CO)) required to remove the first oxygen atom from worse than useless carbon dioxide (CO₂), so as to form the useful carbon monoxide (CO), is 5.5 eV per molecule, which is 127 kcal/mol, or 531.4 kJ/mol. That is even more than the large amount (493 kJ/mol) required for water electrolysis. Removing the second oxygen atom, to produce bare carbon atoms for nanotubes or other forms of solid carbon, requires 257 kcal/mol, or an additional 1075 kJ/mol.

Cracking a metric ton (million grams, or 1.1 short tons (2000 lb.) in English units) of carbon dioxide (22,727 moles) to carbon monoxide takes a total energy input of 12.08 GJ. To crack a one mole input of a mixture of ½ mole of CO₂ and ½ mole of water requires 512.2 kJ/mol, which produces ½ mole of CO, ½ mole of H₂, (i.e. one mole of syngas) and ½ mole of O₂.

Some of the required cracking energy (512.2 kJ/mol)) for the CO₂—H₂O mixture is already present as internal energy, or heat, in the feed to the electrolytic cracker 20. If the CO₂ from the gasifier 1 of an IGCC plant were to be fed into syntrolysis, along with the CO₂ and water from the gas turbine 3 exhaust at a temperature of 600° C. (900 K), the internal energy (heat) is 29.92 kJ/mol or 0.68 GJ/ton of CO₂. The enthalpy of carbon dioxide at 900 K is 37,405 kJ/kmol of which the internal energy (heat) is 29,922 kJ/kmol, 29.92 kJ/mol. Since there are 22,727 moles per ton, the internal energy in a ton of CO₂ turbine exhaust at 900 K is 22,727 mol/ton×29,922 J/mol=0.68 GJ/ton.

Steam at 900 K has an internal energy of approximately 3290 kJ/kg or 59.22 kJ/mol. Adding the waste heat in a mole of CO₂ to the waste heat in a mole of steam gives 89.14 kJ for 2 moles of mixture, or 44.57 kJ/mol of mixture. Instead of using the waste heat in a gas turbine 3 exhaust for a Rankine cycle, that 44.57 kJ/mol internal energy is conserved for carbon cracking, reducing the required 531.4 kJ/mol to 486.83 kJ/mol for cracking one mole of CO₂-water mixture to produce one mole of syngas and ½ mole of O₂. The oxygen is recycled from the electrolytic cracker 20 back into the gasifier 1, resulting in an energy saving of 21.92 kJ per mole of mixture (42.83 kJ/mol O₂ in air separation unit/2). Subtracting the energy savings from oxygen recycling and the internal energy present in the feed to syntrolysis, the net required cracking energy per mole of CO₂-water mixture is 465 kJ/mol. The energy density (heating value) of syngas output by the electrolytic cracker 20 ranges from 5 to 12 MJ/kg depending on the process used in gasification, with oxygen-blown gasification yielding the highest energy density. The syntrolysis product here should be on the high end because the gasifier 1 is oxygen-blown by the recycled oxygen from carbon cracking. Let's say the energy density of syngas from syntrolysis is 12 MJ/kg or 12 kJ/g. Multiplying 12 kJ/g by 30 g (28 grams in a mole of CO+2 grams in a mole of H₂=30 grams in 2 moles of syngas), gives 360 kJ for 2 moles of syngas, and there is one mole of syngas produced by one mole of CO₂—water mixture, so the energy contribution by recycled syngas is 180 kJ per mole of CO₂—water mixture.

A combustor 2 burns the output of the gasifer 1, to drive a gas turbine 3. Recycled into the plant at 85% thermal efficiency, the useful energy (power+heat) in this syngas product is 153 kJ/mol, which is the residue when a mole of CO₂—water mixture is electrolyzed at electrolytic cracker 30—preferably of the radial counterflow type disclosed in U.S. patent application Ser. No. 12/167,771 entitled “Radial Counterflow Shear Electrolysis” by Wilmot H. McCutchen and David J. McCutchen, filed Jul. 3, 2008, US Pat. App. No. 2009/0200176 (Aug. 13, 2009), incorporated by reference herein. So at least part of the energy expended in electrolysis can be recovered. This energy could be immediately output for synthesis of vehicle fuel. Here we examine the utility of recycling syngas for power and heat. Subtracting the heating value of the recycled syngas, as well as the energy savings from recycling oxygen and the internal energy of the feed, the net required cracking energy per mole of CO₂-water mixture is 312 kJ/mol.

Summarizing: each mole of CO₂-water mixture (comprising ½ mole of CO₂ and 1.2 mole of H₂O) requires 312 kJ of cracking energy input at the electrolytic cracker 30.

Bituminous coal (carbon content 60%) has an energy density (heating value) of 24 GJ/ton. Conventional powdered coal plants, even without carbon capture and storage, have a 30% efficiency in converting the coal energy into electricity because waste heat in the steam turbine exhaust is dumped into the atmosphere as latent heat in the vapor from the cooling tower. IGCC plants use heat energy as well as electrical energy in cogeneration. The cogeneration (heat+power) efficiency of IGCC can be as high as 85% so the useful energy in a ton of coal is 20.4 GJ/ton. Both heat and power are conserved in the cycle described here, so assuming 85% efficiency, the energy in a ton of bituminous coal can crack 65,384 CO₂-water mixture moles (20,400,000,000/312,000=65,384). Of the 65,384 moles of mixture cracked by the 20.4 GJ or useful (heat+power) energy in a ton of coal, half, 32,692, are moles of carbon dioxide. There are 22,727 moles per ton of CO₂, so the 32,692 moles of CO₂ cracked by the ton of coal's 20.4 GJ are 1.4 tons of carbon dioxide.

Cracking one ton of carbon dioxide in syntrolysis, with recycling of syngas and oxygen, requires 0.72 tons of bituminous coal delivering 14.57 GJ of useful energy. Each mole of CO₂ cracked by syntrolysis, taking into account all energy savings from recycling oxygen and syngas, as well as the internal energy of the feed, requires an energy expenditure of 641 kJ/mol. This is higher than the energy expenditure for cracking CO₂ alone.

The extra coal (0.72 tons/ton of CO₂) for cracking adds to the CO₂ load. Each ton of the extra bituminous coal (60% carbon) for cracking produces 2.2 tons more CO₂. Each of those additional tons requires 0.72 tons of coal, and so on, adding rather than subtracting emissions.

If water cracking is avoided, and carbon dioxide is cracked directly without syntrolysis, it is still the case that more carbon dioxide is produced by the cracking coal than is cracked by it. Cracking a ton of carbon dioxide (22,727 moles) takes a total energy input of 12.08 GJ (5.5 eV per molecule=531.4 kJ/mole, ×22,727=12.08 GJ), and the internal energy is 0.68 GJ/ton, so 11.4 GJ/ton is the net energy input required for cracking a ton of carbon dioxide. A ton of bituminous coal has a useful energy of 20.4 GJ/ton when its energy is used at 85% thermal efficiency for heating and electricity. Those 20.4 GJ can crack approximately 1.8 tons of CO₂, so each ton of CO₂ requires 0.56 tons of coal. Oxidation of the carbon in the cracking coal adds 2.2 more tons of CO₂, so, although 1.8 tons have been cracked, 2.2 tons have been added, a net 0.4 additional tons of CO₂. As with syntrolysis, using coal energy for cracking to reduce coal CO₂ emissions creates a bigger problem than it solves. Only when the cracking coal is less than 0.45 tons of bituminous coal per ton of CO₂ is there the same amount of CO₂ produced as is cracked. This is a running in place situation where no power is coming out of the plant, and all coal energy is being used to crack coal emissions.

The conclusion that can be drawn from the foregoing is that much more carbon dioxide is produced by the cracking coal than is cracked by it. Using a better grade of coal, such as anthracite (92-98% carbon, 29 GJ/ton) does not change the result that the cracking coal creates more CO₂ than it cracks. Clearly some additional energy input, besides coal, is needed for CO₂ cracking, which is the only hope for avoiding global climate catastrophe from greenhouse gas emissions.

Wind and solar and other intermittent power sources (not shown) can provide such additional energy input for carbon cracking at the electrolytic crackers 20 and 30. Although not reliable enough to provide baseload power to the grid, they nevertheless can ameliorate the emissions of the coal which provides the base load power.

Also, the spinning reserve is already available anyway, so carbon cracking is a way the spinning reserve can be used instead of going to waste. At least some of the CO₂ produced by the plant could be rendered harmless, and even converted into valuable products.

In the hybrid power system disclosed herein, renewable power is used to crack fossil fuel CO₂ emissions. The CO₂ could be transported to a location where renewables are available, for cracking off-site, or renewables power could be transmitted to emission sites. The problem of connecting renewable power to the grid is avoided by using that power to clean up after coal and natural gas power generation. Captured and stored CO₂ becomes, in effect, a way to make use of renewable energy during the times when it is abundant. Carbon dioxide is tantamount to a medium of renewable energy storage.

If syntrolysis is practiced by renewables, the syngas produced from carbon dioxide would be a valuable byproduct of carbon cracking which could be processed into vehicle fuel. Vehicle fuel then becomes the energy storage of renewables.

Wind is a rapidly growing sector, with 94,000 MW of installed capacity as of 2008 which is projected to grow to 253,000 MW by 2012. But there is a fundamental limit on integrating wind power into the grid, because it wind is intermittent and not widely deployed enough that becalmed wind sites cannot be backstopped by functioning wind generators elsewhere. Therefore wind cannot provide baseload power unless some storage medium can be found. Currently, new coal plants are stalled by emissions problems. If wind could overcome the emissions problems of coal, and coal could continue to provide reliable baseload power for the grid, then the potential of wind could be put to use and new coal plants could be approved. Wind could be widely deployed with a useful job to do: crack coal emissions.

For a coal gasification plant using bituminous coal at 50% efficiency (i.e. a gas turbine, without the water-wasting Rankine cycle, and using all of the waste heat for cracking), each MWhr (3.6 GJ) of power output requires 0.3 tons of coal. So a 250 MW coal plant would use 75 tons of coal for an hour of operation, providing 250,000 kilowatt-hours of power. The 75 tons of coal produce 165 tons of CO₂ emissions. The help needed from wind power to crack 165 tons by direct carbon dioxide cracking without syntrolysis (requiring cracking energy of 11.4 GJ/ton of CO₂) is 1881 GJ, which is 522,500 kWhr of wind power. A wind farm producing 100 MW could crack the emissions from an hour of coal operations in 18810 seconds, or a little over 5 hours. But these 5 hours of wind power could come at any time and at any place. Storage of CO₂ at the power plant would buffer the feed to wind-driven crackers, or the CO₂ could be transported to places where wind is abundant. Even if only half of the CO₂ emissions could be cracked by renewable power, still there would be quantifiable progress.

The solid carbon produced by CO₂ cracking at the electrolytic crackers 20 and 30 is a valuable product. Carbon nanotubes are 100 times stronger than steel, and they are excellent conductors. Their value, by weight, exceeds gold. So each ton of recovered solid carbon could be well worth the energy expenditure for carbon cracking. A profit incentive based on the value of carbon cracking byproducts would be a greater stimulus for rapid progress in reducing carbon dioxide emissions than scolding or punitive taxation. Rather than spend money on reducing emissions, existing coal plants will simply pay any carbon tax and pass on the added cost to the power consumers. Hybrid power according to the present invention would provide existing coal plants a profit incentive to implement post-combustion carbon capture and treatment.

Once we recognize that sequestration won't be a solution to emissions, and hydrogen won't be a solution to renewable energy storage, it becomes clear that carbon cracking in hybrid power generation is worthy of investigation. The prospect of converting trash to treasure (carbon nanotubes) should insure quick adoption, and quick reduction of CO₂ emissions, by big and recalcitrant polluters.

A hybrid power generation system is a combination of power plants using carbonaceous fuels—such as coal, natural gas, or biomass—and intermittent natural sources—such as wind, photovoltaic solar, concentrating solar, or tidal. The intermittent sources in the partnership electrolytically crack the CO₂ from carbonaceous fuels, and the power plants produce baseload power with reduced emissions. The best features of each partner in this combination offset the worst features of the other, so as to provide reliable power with minimal emissions. Carbon dioxide would become, in effect, a way to take advantage of intermittent natural energy sources which would otherwise be wasted because of grid connection problems. Wide deployment of renewables can proceed without regard to grid connection problems, and eventually might replace fossil fuels when wide deployment overcomes intermittency.

As used herein, “means for delivering CO₂” from the carbonaceous fuel power plants to the location of electrolytic cracking may include, for example, pipelines to sites where wind or solar is abundant, transmission lines from said sites to said power plants, or combinations thereof whereby cracking can occur at convenient locations.

As used herein, “means for electrolytic cracking” may include, for example, the device described in U.S. patent application Ser. No. 12/167,771 entitled “Radial Counterflow Shear Electrolysis” by Wilmot H. McCutchen and David J. McCutchen, filed Jul. 3, 2008, US Pat. App. No. 2009/0200176 (Aug. 13, 2009), incorporated by reference herein.

As used herein, “means for delivering oxygen” from the means for electrolytic cracking may include, for example, one or more pipelines to power plants such as carbonaceous fuel power plants.

As used herein, “means for recovery of carbon nanotubes from CO₂” may include, for example, the device described in U.S. patent application Ser. No. 12/368,236 entitled “Shear Reactor for Vortex Synthesis of Nanotubes” by David J. McCutchen and Wilmot H. McCutchen, filed Feb. 9, 2009, US Pat. App. No. 2009/0263309 (Oct. 22, 2009), incorporated by reference herein.

We claim:

1. A hybrid power system, comprising:
a power plant wherein energy from carbonaceous fuel is used to produce electric power, the power plant producing waste products including CO₂;
a source of energy selected from the group consisting of wind, photovoltaic solar, concentrating solar, and tidal;
means for electrolytic cracking of CO₂, said cracking means powered at least in part by said energy source; and
means for delivering CO₂ from said power plant to said means for electrolytic cracking.

2. The hybrid power system of claim 1, further comprising means for delivering oxygen from said means for electrolytic cracking of CO₂ to the power plant.

3. The hybrid power system of claim 1, further comprising means for simultaneous electrolysis of carbon dioxide and water to produce syngas.

4. The hybrid power system of claim 1, further comprising means for recovery of carbon nanotubes from CO₂.
